(19) United States
(12) Patent Application Publication
(10) Pub. No.: US 2024/0345609 A1
(43) Pub. Date: Oct. 17, 2024

(54) LINEAR POWER CONVERTER CIRCUIT WITH SURGE PROTECTION CIRCUIT

(71) Applicant: TRITIUM ELECTRONICS PTE. LTD., Singapore (SG)

(72) Inventors: Zhi-Xin Chen, Hsinchu (TW); Lu-An Chen, Hsinchu (TW)

(21) Appl. No.: 18/629,982

(22) Filed: Apr. 9, 2024

Related U.S. Application Data
(60) Provisional application No. 63/496,009, filed on Apr. 13, 2023.

(51) Int. Cl. G05F 1/569; G05F 1/56; G05F 1/575; H02M 1/32

(52) U.S. Cl. CPC G05F 1/569; G05F 1/561; G05F 1/575; H02M 1/32

(57) ABSTRACT

A linear power converter circuit comprising: an output transistor, wherein a gate of the output transistor is controlled by an error amplification signal for converting an input voltage into an output voltage; an error amplification circuit configured to amplify a difference between a reference voltage and a feedback voltage to generate the error amplification signal, thereby regulating the output voltage to a predetermined level, wherein the feedback voltage is related to the output voltage; and a first surge protection circuit configured to clamp the gate-source voltage of the output transistor when the slew rate of the input voltage exceeds a threshold, thereby limiting the current through the output transistor to not exceed a predetermined upper limit.

### CROSS REFERENCE

The present invention claims priority to U.S. 63/496,009 filed on Apr. 13, 2023.

### BACKGROUND OF THE INVENTION

### Field of Invention

The present invention relates to a linear power converter circuit; particularly, it relates to such linear power converter circuit that can prevent over voltage issues caused during power ON and enhance electrostatic protection capabilities.

### Description of Related Art

FIG. 1 shows a schematic diagram of a prior art linear regulator circuit. When an input voltage VDD is powered ON rapidly or when static electricity occurs, a control resistor R1 and an output stage parasitic capacitance CP generate signal delay, leading to an increase in the voltage difference between the input voltage VDD and the gate voltage VG. This causes the output stage P-type transistor MP1 to conduct and enter the linear region. The P-type transistor MP1 operating in the linear region generates a large current Ip flowing into the output VO, causing the linear regulator output to generate an overshoot voltage. This current and voltage overshoot can easily damage the output stage P-type transistor MP1 and/or the core circuit due to overvoltage. FIG. 2 shows a schematic diagram of another prior art linear regulator circuit. This other prior art linear regulator circuit forms a low-pass filter by serially connecting a resistor RI and adding a capacitor CI in front of the power supply. This reduces high-frequency components to become smoother after the power ON signal is filtered through the low-pass filter, thereby reducing the voltage difference between the input voltage VDD and the gate voltage VG during power ON. However, this approach requires a large time constant, and a high resistor value causes an I*R voltage drop when the chip is powered normally, while a large capacitor value cannot be implemented within the chip and also causes additional area waste and material costs on the circuit board. On the other hand, this other prior art linear regulator circuit cannot prevent the P-type transistor MP1 from conducting during an electrostatic strike because an electrostatic protection device can only protect in high voltage areas. However, an electrostatic strike will conduct the P-type transistor MP1 first, so the electrostatic protection device cannot protect the P-type transistor MP1 in time, resulting in the linear regulator output generating an overshoot voltage and causing damage to the output stage P-type transistor MP1 and/or the core circuit due to overvoltage.

In view of this, the present invention proposes a linear power converter circuit that can prevent over voltage issues caused during power ON and enhance electrostatic protection capabilities.

### SUMMARY OF THE INVENTION

The present invention provides a linear power converter circuit with a surge protection circuit, comprising: an output transistor, a gate of which is controlled by an error amplification signal for converting an input voltage and generating an output voltage; an error amplification circuit for amplifying a difference between a reference voltage and a feedback voltage to generate the error amplification signal, thereby regulating the output voltage to a predetermined level, wherein the feedback voltage is related to the output voltage; and a first surge protection circuit for clamping a gate-source voltage of the output transistor when a conversion rate of the input voltage exceeds a threshold, to limit a current of the output transistor not to exceed a predetermined upper limit.

In one embodiment, the first surge protection circuit includes: a first clamping transistor; and a first filter for filtering the input voltage to generate a first clamping control signal, for controlling the first clamping transistor, thereby, when the conversion rate of the input voltage exceeds the threshold, turning ON the first clamping transistor, and thereby clamping the gate-source voltage of the output transistor to limit the current of the output transistor not to exceed the predetermined upper limit.

In one embodiment, the output transistor and the first clamping transistor are both P-type transistors.

In one embodiment, the first filter is a low-pass filter.

In one embodiment, the low-pass filter comprises a first filtering resistor and a first filtering capacitor, the first filtering resistor and the first filtering capacitor being serially connected and coupled between the input voltage and a ground potential, the first filtering resistor and the first filtering capacitor being coupled to the first clamping transistor.

In one embodiment, the error amplification circuit includes an amplifier and an amplifying transistor; the linear power converter circuit further comprises a second surge protection circuit for clamping the gate-source voltage of the amplifying transistor when the conversion rate of the input voltage exceeds the threshold, to limit the current of the amplifying transistor not to exceed a predetermined upper limit.

In one embodiment, the second surge protection circuit includes: a second clamping transistor; and a second filter for filtering the input voltage to generate a second clamping control signal, for controlling the second clamping transistor.

In one embodiment, he amplifying transistor and the second clamping transistor are both N-type transistors.

In one embodiment, the second filter is a high-pass filter.

In one embodiment, the high-pass filter comprises a second filtering capacitor and a second filtering resistor, the second filtering capacitor and the second filtering resistor being serially connected and coupled between the input voltage and a ground potential, the second filtering resistor and the second filtering capacitor being coupled to the second clamping transistor.

In one embodiment, the gate of the output transistor has a first equivalent capacitor, and there is a first equivalent resistor between the gate of the output transistor and the input voltage, wherein a bandwidth of the low-pass filter is lower than a bandwidth corresponding to a product of the resistance of the first equivalent resistor and the capacitance of the first equivalent capacitor to a degree, such that when the conversion rate of the input voltage exceeds the threshold, the first clamping transistor is turned ON by the first clamping control signal, thereby clamping the gate-source voltage of the output transistor to limit the current of the output transistor not to exceed the predetermined upper limit.

In one embodiment, the amplifier has an equivalent output resistance, the gate of the amplifying transistor is coupled to a second equivalent capacitor, wherein a bandwidth of the high-pass filter is lower than a bandwidth corresponding to a product of the resistance of the equivalent output resistance and the capacitance of the second equivalent capacitor to a degree, such that when the conversion rate of the input voltage exceeds the threshold, the second clamping transistor is turned ON by the second clamping control signal, thereby clamping the gate-source voltage of the amplifying transistor to limit a current of the amplifying transistor not to exceed the predetermined upper limit.

In one embodiment, a bandwidth of the low-pass filter is lower than an input bandwidth to a degree, such that when the conversion rate of the input voltage exceeds the threshold, the first clamping transistor is turned ON by the first clamping control signal, thereby clamping the gate-source voltage of the output transistor to limit the current of the output transistor not to exceed the predetermined upper limit, wherein the input bandwidth corresponds to a bandwidth associated with a product of an inverse of the conversion rate of the input voltage and the input voltage.

In one embodiment, a bandwidth of the high-pass filter is lower than an input bandwidth to a degree, such that when the conversion rate of the input voltage exceeds the threshold, the second clamping transistor is turned ON by the second clamping control signal, thereby clamping the gate-source voltage of the amplifying transistor to limit the current of the amplifying transistor not to exceed the predetermined upper limit, wherein the input bandwidth corresponds to a bandwidth associated with a product of an inverse of the conversion rate of the input voltage and the input voltage.

In one embodiment, the conversion rate of the input voltage corresponds to a voltage conversion rate of the input voltage during power ON, or corresponds to a voltage conversion rate of the input voltage when subjected to an Electro-Static Discharge (ESD).

The advantage of the present invention is that it can prevent over voltage issues caused during power ON and enhance electrostatic protection capabilities.

The objectives, technical details, features, and effects of the present invention will be better understood with regard to the detailed description of the embodiments below, with reference to the attached drawings.

### BRIEF DESCRIPTION OF THE DRAWINGS

FIG. 1 is a schematic diagram of a prior art linear regulator circuit.

FIG. 2 is a schematic diagram of another prior art linear regulator circuit.

FIG. 3 is a block diagram of a linear power converter circuit according to one embodiment of the present invention.

FIG. 4 is a schematic diagram of a first surge protection circuit of the linear power converter circuit according to one embodiment of the present invention.

FIG. 5 is a schematic diagram of a first surge protection circuit of the linear power converter circuit according to one embodiment of the present invention.

FIG. 6 is a schematic diagram of a first surge protection circuit of the linear power converter circuit according to one embodiment of the present invention.

FIG. 7 is a schematic diagram of an error amplification circuit and a second surge protection circuit of the linear power converter circuit according to one embodiment of the present invention.

FIG. 8 is a schematic diagram of a second surge protection circuit of the linear power converter circuit according to one embodiment of the present invention.

FIG. 9 is a schematic diagram of a second surge protection circuit of the linear power converter circuit according to one embodiment of the present invention.

FIG. 10 is a schematic diagram of a second surge protection circuit of the linear power converter circuit according to one embodiment of the present invention.

FIG. 11 is a schematic diagram of the linear power converter circuit according to one embodiment of the present invention.

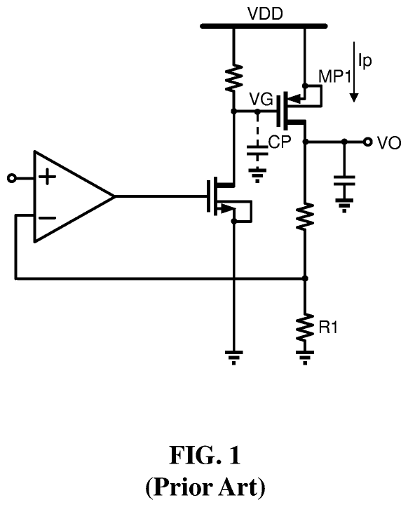

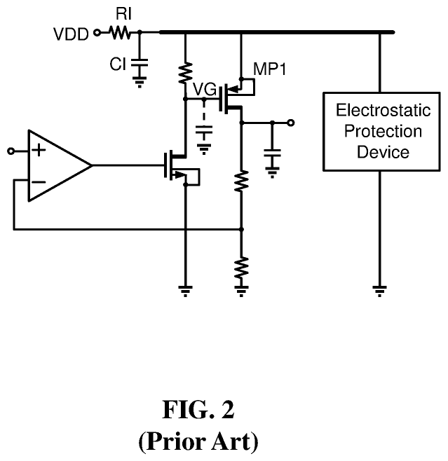

### DESCRIPTION OF THE PREFERRED EMBODIMENTS

The drawings as referred to throughout the description of the present invention are for illustration only, to show the interrelations between the circuits and the signal waveforms, but not drawn according to actual scale.

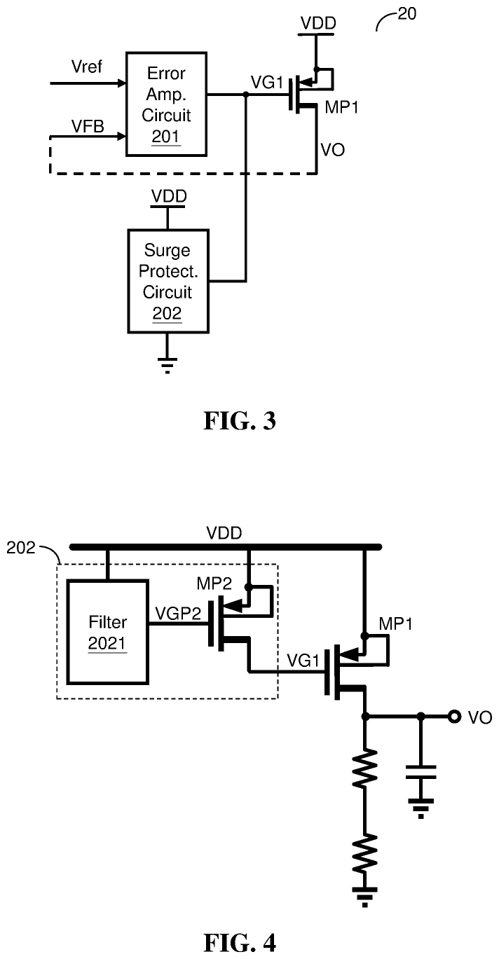

FIG. 3 is a block diagram of a linear power converter circuit according to one embodiment of the present invention. As shown in FIG. 3, the linear power converter circuit 20 of the present invention includes an output transistor MP1, an error amplification circuit 201, and a surge protection circuit 202. The gate of the output transistor MP1 is controlled by the error amplification signal VG1, which converts the input voltage VDD and generates the output voltage VO, while the error amplification circuit 201 amplifies the difference between the reference voltage Vref and the feedback voltage VFB to generate the error amplification signal VG1, thereby regulating the output voltage VO to a predetermined level. In one embodiment, the feedback voltage VFB is related to the output voltage VO. The surge protection circuit 202 is configured to clamp a gate-source voltage of the output transistor MP1 when a conversion rate (slew rate) of the input voltage VDD exceeds a threshold, to limit the current of the output transistor MP1 to not exceed a predetermined upper limit. In one embodiment, the conversion rate of the input voltage VDD corresponds to a voltage conversion rate of the input voltage VDD during power ON, or to the voltage conversion rate of the input voltage VDD when subjected to Electro-Static Discharge (ESD).

FIG. 4 is a schematic diagram of a surge protection circuit of the linear power converter circuit according to one embodiment of the present invention. As shown in FIG. 4, the surge protection circuit 202 includes a clamping transistor MP2 and a filter 2021. The filter 2021 filters the input voltage VDD to generate a clamping control signal VGP2 to control the clamping transistor MP2, such as its gate, thereby conducting the clamping transistor MP2 when the conversion rate of the input voltage VDD exceeds the threshold, and thereby clamping the gate-source voltage of the output transistor MP1 to limit the current of the output transistor MP1 to not exceed the predetermined upper limit. In one embodiment, both the output transistor MP1 and the clamping transistor MP2 are P-type transistors.

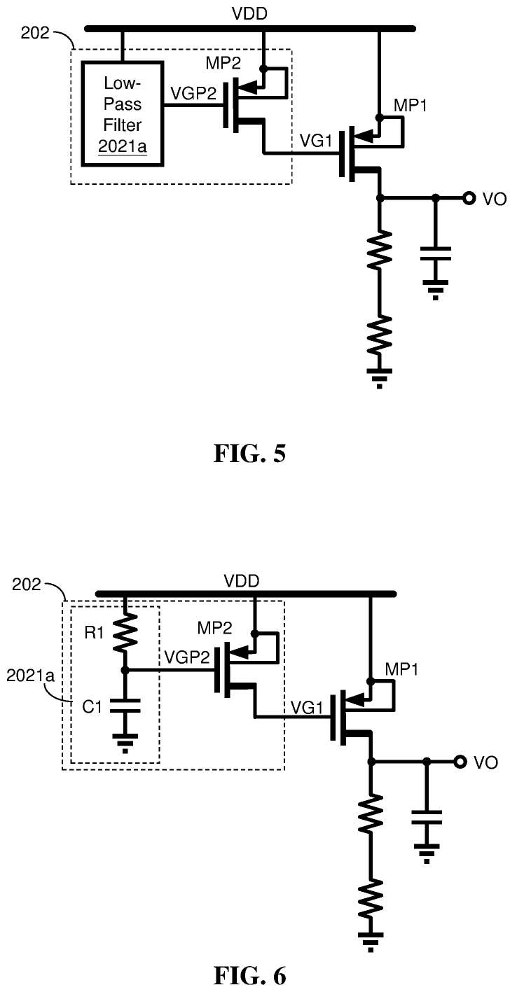

FIG. 5 is a schematic diagram of a surge protection circuit of the linear power converter circuit according to one embodiment of the present invention. As shown in FIG. 5, this embodiment corresponds to a specific embodiment of FIG. 4, wherein the filter in this embodiment is a low-pass filter 2021a.

FIG. 6 is a schematic diagram of a surge protection circuit of the linear power converter circuit according to one embodiment of the present invention. As shown in FIG. 6, this embodiment corresponds to a specific embodiment of FIG. 5, wherein the low-pass filter 2021a includes a first filter resistor R1 and a first filter capacitor C1. The first filter resistor R1 and the first filter capacitor C1 are serially connected and coupled between the input voltage VDD and the ground potential, and are coupled to the gate of the clamping transistor MP2, for example.

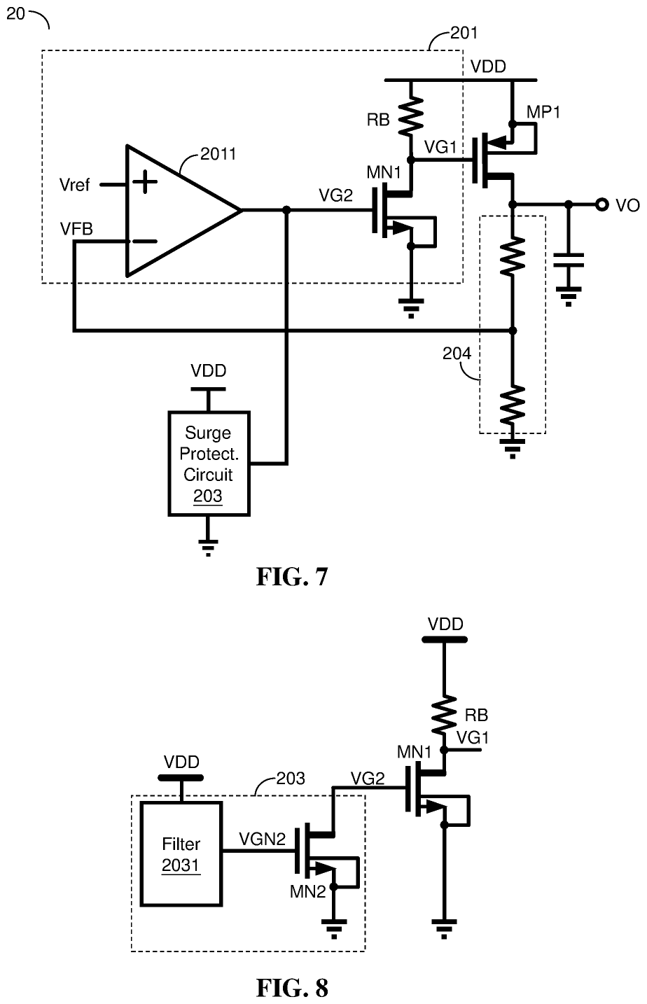

FIG. 7 is a schematic diagram of an error amplification circuit and a surge protection circuit of the linear power converter circuit according to one embodiment of the present invention. As shown in FIG. 7, the error amplification circuit 201 includes an amplifier 2011 and an amplifying transistor MN1. The amplifier 2011 amplifies the difference between the reference voltage Vref and the feedback voltage VFB to generate the error amplification signal VG2, which is then configured to generate the error amplification signal VG1 through a single-stage amplifier (such as including the transistor MN1 and resistor RB), thereby regulating the output voltage VO to a predetermined level. In this embodiment, the linear power converter circuit 20 further includes a surge protection circuit 203, configured to clamp the gate-source voltage of the amplifying transistor MN1 when the conversion rate of the input voltage VDD exceeds the threshold, to limit the current of the amplifying transistor MN1 to not exceed a predetermined upper limit. In one embodiment, the feedback circuit 204, such as a voltage divider, is configured to divide the output voltage VO to generate the feedback voltage VFB.

FIG. 8 is a schematic diagram of a surge protection circuit of the linear power converter circuit according to one embodiment of the present invention. As shown in FIG. 8, the surge protection circuit 203 includes a clamping transistor MN2 and a filter 2031. The filter 2031 filters the input voltage VDD to generate a clamping control signal VGN2 to control the clamping transistor MN2, such as via its gate. In one embodiment, both the amplifying transistor MN1 and the clamping transistor MN2 are N-type transistors.

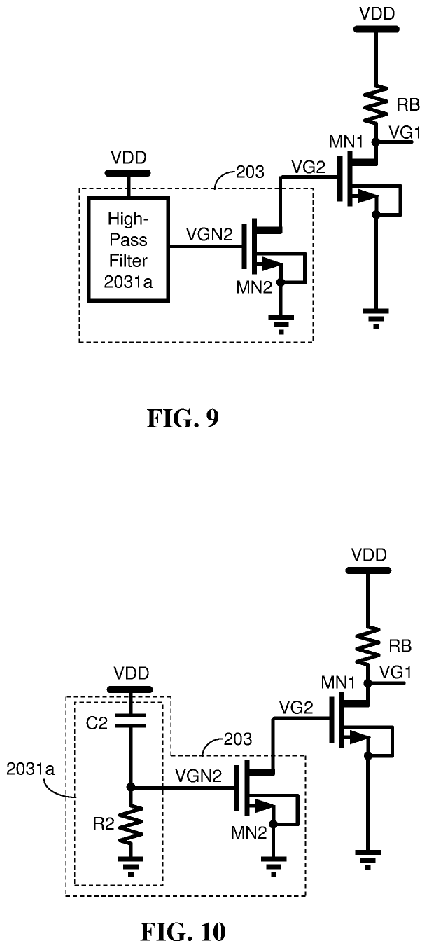

FIG. 9 is a schematic diagram of a surge protection circuit of the linear power converter circuit according to one embodiment of the present invention. This embodiment corresponds to a specific embodiment of FIG. 8, wherein the filter within the surge protection circuit 203 in this embodiment is a high-pass filter 2031a.

FIG. 10 is a schematic diagram of a surge protection circuit of the linear power converter circuit according to one embodiment of the present invention. This embodiment corresponds to a specific embodiment of FIG. 9, wherein the high-pass filter 2031a includes a second filter capacitor C2 and a second filter resistor R2. The second filter capacitor C2 and the second filter resistor R2 are serially connected and coupled between the input voltage VDD and the ground potential, and are coupled to the clamping transistor MN2, such as its gate.

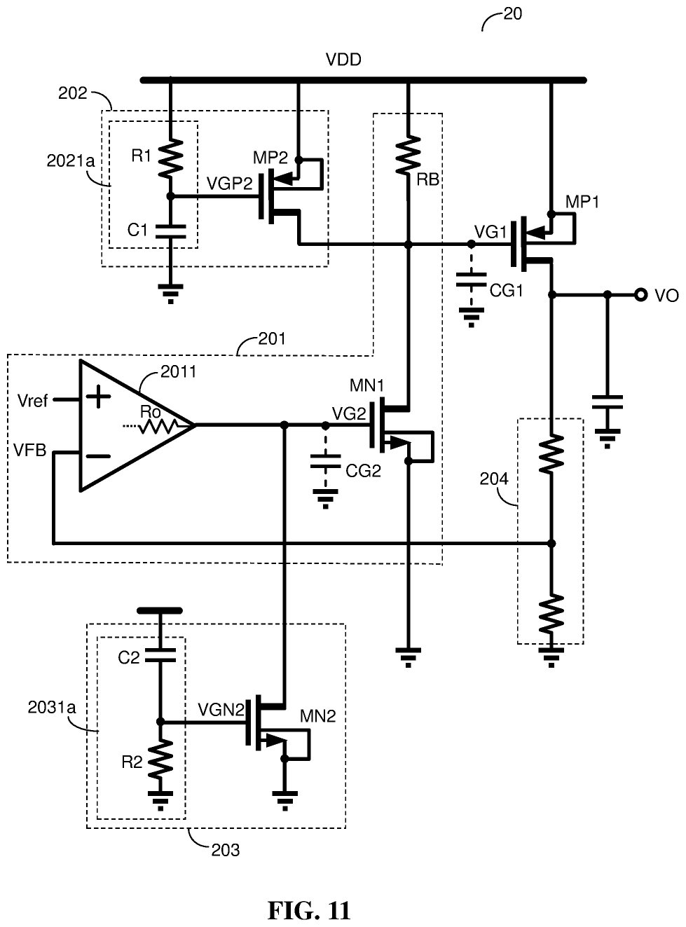

FIG. 11 is a schematic diagram of the linear power converter circuit according to one embodiment of the present invention. This embodiment is a specific embodiment of FIG. 3. As shown in FIG. 11, the gate of the output transistor MP1 is coupled to a node which has an equivalent capacitor CG1, and there is an equivalent resistor (approximately equivalent to resistor RB) between the gate of the output transistor MP1 and the input voltage VDD. In one embodiment, the bandwidth of the low-pass filter 2021a is less than the bandwidth corresponding to the product of the resistance of the equivalent resistor and the capacitance of the equivalent capacitor CG1 to a degree, such that when the conversion rate of the input voltage VDD exceeds the threshold, the clamping transistor MP2 is controlled by the clamping control signal VGP2 to conduct, thereby clamping the gate-source voltage of the output transistor MP1, to limit the current of the output transistor MP1 to not exceed the predetermined upper limit. From one perspective, the product of the resistance of the first filter resistor R1 and the capacitance of the first filter capacitor C1, also known as the time constant, is significantly greater than the product of the resistance of the equivalent resistor and the capacitance of the equivalent capacitor CG1 to a degree, such that when the conversion rate of the input voltage VDD exceeds the threshold, the clamping transistor MP2 is controlled by the clamping control signal VGP2 to conduct, thereby clamping the gate-source voltage of the output transistor MP1, to limit the current of the output transistor MP1 to not exceed the predetermined upper limit.

Please refer to FIG. 11, the amplifier 2011 has an equivalent output resistance Ro, and a node to which the gate of the amplifying transistor MN1 is coupled has an equivalent capacitor CG2. In one embodiment, the bandwidth of the high-pass filter 2031a is less than the bandwidth corresponding to the product of the resistance of the equivalent output resistance Ro and the capacitance of the equivalent capacitor CG2 to a degree, such that when the conversion rate of the input voltage VDD exceeds the threshold, the clamping transistor MN2 is controlled by the clamping control signal VGN2 to conduct, thereby clamping the gate-source voltage of the amplifying transistor MN1, to limit the current of the amplifying transistor MN1 to not exceed the predetermined upper limit. In one embodiment, the product of the resistance of the second filter resistor R2 and the capacitance of the second filter capacitor C2, also known as the time constant, is significantly greater than the product of the resistance of the equivalent output resistance Ro and the capacitance of the equivalent capacitor CG2 to a degree, such that when the conversion rate of the input voltage VDD exceeds the threshold, the clamping transistor MN2 is controlled by the clamping control signal VGN2 to conduct, thereby clamping the gate-source voltage of the amplifying transistor MN1, to limit the current of the amplifying transistor MN1 to not exceed the predetermined upper limit.

In one embodiment, the bandwidth of the low-pass filter 2021a is less than a bandwidth corresponding to a product of an inverse of the conversion rate of the input voltage VDD and the the input voltage VDD to a degree, ensuring that when the conversion rate of the input voltage VDD exceeds the threshold, the clamping transistor MP2 is controlled by the clamping control signal VGP2 to conduct, thereby clamping the gate-source voltage of the output transistor MP1, to limit the current of the output transistor MP1 to not exceed the predetermined upper limit. From one perspective, the product of the resistance of the first filter resistor R1 and the capacitance of the first filter capacitor C1 is greater than the product of the inverse of the conversion rate of the input voltage VDD and the input voltage VDD to a degree, ensuring that when the conversion rate of the input voltage VDD exceeds the threshold, the clamping transistor MP2 is controlled by the clamping control signal VGP2 to conduct, thereby clamping the gate-source voltage of the output transistor MP1, to limit the current of the output transistor MP1 to not exceed the predetermined upper limit.

In one embodiment, the bandwidth of the high-pass filter 2031a is less than the bandwidth corresponding to the product of an inverse of the conversion rate of the input voltage VDD and the input voltage VDD to a degree, ensuring that when the conversion rate of the input voltage VDD exceeds the threshold, the clamping transistor MN2 is controlled by the clamping control signal VGN2 to conduct, thereby clamping the gate-source voltage of the amplifying transistor MN1, to limit the current of the amplifying transistor MN1 to not exceed the predetermined upper limit. In one embodiment, the product of the resistance of the second filter resistor R2 and the capacitance of the second filter capacitor C2 is greater than the product of the inverse of the conversion rate of the input voltage VDD and the input voltage VDD to a degree, ensuring that when the conversion rate of the input voltage VDD exceeds the threshold, the clamping transistor MN2 is controlled by the clamping control signal VGN2 to conduct, thereby clamping the gate-source voltage of the amplifying transistor MN1, to limit the current of the amplifying transistor MN1 to not exceed the predetermined upper limit.

In summary, the present invention can prevent overvoltage problems caused during power ON and enhance electrostatic protection capabilities. By integrating surge protection circuits with specific filtering configurations, the invention effectively manages the dynamic responses of the circuit to rapid changes in input voltage, such as those caused by power surges or electrostatic discharge, thereby protecting sensitive components from potential damage. The detailed descriptions of the embodiments, including the specific arrangements of clamping transistors and filters, demonstrate a comprehensive approach to managing both low and high frequency disturbances, ensuring the linear power converter circuit maintains stable operation under a variety of challenging conditions.

The present invention has been described in considerable detail with reference to certain preferred embodiments thereof. It should be understood that the description is for illustrative purpose, not for limiting the scope of the present invention. Those skilled in this art can readily conceive variations and modifications within the spirit of the present invention. The various embodiments described above are not limited to being used alone; two embodiments may be used in combination, or a part of one embodiment may be used in another embodiment. For example, other process steps or structures, such as a metal silicide layer, may be added. For another example, the lithography process step is not limited to the mask technology but it can also include electron beam lithography, immersion lithography, etc. Therefore, in the same spirit of the present invention, those skilled in the art can think of various equivalent variations and various combinations, and there are many combinations thereof, and the description will not be repeated here. The scope of the present invention should include what are defined in the claims and the equivalents.

What is claimed is:

1. A linear power converter circuit with a surge protection circuit, comprising:
an output transistor, a gate of which is controlled by an error amplification signal, wherein the output transistor is configured to operably convert an input voltage and generate an output voltage;
an error amplification circuit, which is configured to operably amplify a difference between a reference voltage and a feedback voltage to generate the error amplification signal, thereby regulating the output voltage to a predetermined level, wherein the feedback voltage is related to the output voltage; and
a first surge protection circuit, which is configured to operably clamp a gate-source voltage of the output transistor when a conversion rate of the input voltage exceeds a threshold, to limit a current of the output transistor not to exceed a predetermined upper limit.

2. The linear power converter circuit of claim 1, wherein the first surge protection circuit includes:
a first clamping transistor; and
a first filter, which is configured to operably filter the input voltage to generate a first clamping control signal, for controlling the first clamping transistor, thereby, when the conversion rate of the input voltage exceeds the threshold, turning ON the first clamping transistor, and thereby clamping the gate-source voltage of the output transistor to limit the current of the output transistor not to exceed the predetermined upper limit.

3. The linear power converter circuit of claim 2, wherein the output transistor and the first clamping transistor are both P-type transistors.

4. The linear power converter circuit of claim 2, wherein the first filter is a low-pass filter.

5. The linear power converter circuit of claim 4, wherein the low-pass filter comprises a first filtering resistor and a first filtering capacitor, wherein the first filtering resistor and the first filtering capacitor are serially connected and coupled between the input voltage and a ground potential, and the first filtering resistor and the first filtering capacitor are coupled to the first clamping transistor.

6. The linear power converter circuit of claim 1, wherein the error amplification circuit includes an amplifier and an amplifying transistor; wherein the linear power converter circuit further comprises a second surge protection circuit for clamping the gate-source voltage of the amplifying transistor when the conversion rate of the input voltage exceeds the threshold, to limit the current of the amplifying transistor not to exceed a predetermined upper limit.

7. The linear power converter circuit of claim 6, wherein the second surge protection circuit includes:
a second clamping transistor; and
a second filter for filtering the input voltage to generate a second clamping control signal, for controlling the second clamping transistor.

8. The linear power converter circuit according to claim 7, wherein the amplifying transistor and the second clamping transistor are both N-type transistors.

9. The linear power converter circuit according to claim 7, wherein the second filter is a high-pass filter.

10. The linear power converter circuit according to claim 9, wherein the high-pass filter comprises a second filtering capacitor and a second filtering resistor, the second filtering capacitor and the second filtering resistor being serially connected and coupled between the input voltage and a ground potential, the second filtering resistor and the second filtering capacitor being coupled to the second clamping transistor.

11. The linear power converter circuit according to claim 4, wherein the gate of the output transistor has a first equivalent capacitor, and there is a first equivalent resistor between the gate of the output transistor and the input voltage, wherein a bandwidth of the low-pass filter is lower than a bandwidth corresponding to a product of the resistance of the first equivalent resistor and the capacitance of the first equivalent capacitor to a degree, such that when the conversion rate of the input voltage exceeds the threshold, the first clamping transistor is turned ON by the first clamping control signal, thereby clamping the gate-source voltage of the output transistor to limit the current of the output transistor not to exceed the predetermined upper limit.

12. The linear power converter circuit according to claim 9, wherein the amplifier has an equivalent output resistance, the gate of the amplifying transistor is coupled to a second equivalent capacitor, wherein a bandwidth of the high-pass filter is lower than a bandwidth corresponding to a product of the resistance of the equivalent output resistance and the capacitance of the second equivalent capacitor to a degree, such that when the conversion rate of the input voltage exceeds the threshold, the second clamping transistor is turned ON by the second clamping control signal, thereby clamping the gate-source voltage of the amplifying transistor to limit a current of the amplifying transistor not to exceed the predetermined upper limit.

13. The linear power converter circuit according to claim 4, wherein a bandwidth of the low-pass filter is lower than an input bandwidth to a degree, such that when the conversion rate of the input voltage exceeds the threshold, the first clamping transistor is turned ON by the first clamping control signal, thereby clamping the gate-source voltage of the output transistor to limit the current of the output transistor not to exceed the predetermined upper limit, wherein the input bandwidth corresponds to a bandwidth associated with a product of an inverse of the conversion rate of the input voltage and the input voltage.

14. The linear power converter circuit according to claim 10, wherein a bandwidth of the high-pass filter is lower than an input bandwidth to a degree, such that when the conversion rate of the input voltage exceeds the threshold, the second clamping transistor is turned ON by the second clamping control signal, thereby clamping the gate-source voltage of the amplifying transistor to limit the current of the amplifying transistor not to exceed the predetermined upper limit, wherein the input bandwidth corresponds to a bandwidth associated with an inverse of the conversion rate of the input voltage and the product of the input voltage.

15. The linear power converter circuit according to claim 14, wherein the conversion rate of the input voltage corresponds to a voltage conversion rate of the input voltage during power ON, or corresponds to a voltage conversion rate of the input voltage when subjected to an Electro-Static Discharge (ESD).
